(19) United States
(12) Patent Application Publication
(10) Pub. No.: US 2008/0054530 A1
(43) Pub. Date: Mar. 6, 2008

(54) Pre-Impregnated Sheet With Bound Fibers

(75) Inventors: Claude Choudin, Saint Jean D'Arvey (FR); Francois Roederer, Chambery (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Vetrotex France S.A., Chambery (FR)

(21) Appl. No.: 11/576,534

(22) PCT Filed: Sep. 27, 2005
(86) PCT No.: PCT/FR05/50785

§ 371 Date: Nov. 12, 2007

(30) Foreign Application Priority Data
Oct. 7, 2004 (FR) 0452304

(51) Int. Cl. C08J 5/04; C08K 9/04

(52) U.S. Cl. 264/331.11; 523/200; 523/217

(57) ABSTRACT

The invention relates to a sheet molding compound comprising a thermosetting resin and a fibrous structure bonded by a solvent soluble in said thermosetting resin. During manufacture by hot compression molding of the composite, the binder dissolves and frees the fibers of the fibrous structure, allowing the structure to flow and fill the entire mold for manufacturing the composite. A fibrous structure containing continuous strands or chopped strands may be used. The binder allows the fibrous structure to be handled, wound and stored before it is incorporated into the sheet molding compound.

The invention relates to the production of a sheet molding compound or prepreg sheet with reinforcement in the form of chopped or continuous strands and to its conversion into a composite.

A sheet molding compound (SMC), synonymous with a prepreg sheet, is an assembly comprising a reinforcement and a heat-curable resin pastes said assembly being intended to be converted during a hot molding step into a composite component.

Molding using an SMC is usually carried out in the following manner:
a sheet of SMC, cut to the shape of the final component, but representing only a portion of the total finished area, is placed in the mold; and then
the sheet is hot-pressed in order to make the resin fluid-like and then to cure said resin, the compression being sufficient to make the softened SMC flow so that it fills the entire internal surface of the mold.

In the prior art, the reinforcement is usually chopped strand, the copping being carried out directly above a resin paste during manufacture of the SMC. In the mold, the SMC is subjected to pressure and it must flow easily in order to fill the entire volume of the mold under the effect of the pressure. For those skilled in the art, this flow is possible owing to the fact that the strands are chopped but not bonded, and they can easily move one with respect to another. The SMC area before pressing represents only a portion of the area of the final composite. The entire area is achieved through the effect of the pressing. According to the prior art, to produce an SMC sheet, chopped strands are sprayed onto a moving web of resin-based paste and then another web of paste is deposited on top, imprisoning the chopped strands as in a sandwich. Next, the SMC is wound up and stored. The sheet is then unwound in order to cut out a part (usually called a “prepreg blank”), the area of which represents only a portion of the area of the final part, and said part is placed in a mold and hot-molded in a molding machine. The thermosetting resin cures during this treatment.

An SMC manufacturing unit is therefore necessarily quite complex, as it has to include a chopper, for chopping the strand above the paste. However, it may be desirable to produce the reinforcement on a site dedicated to strand chopping and to assembly it in the SMC on a site dedicated to SMC assembly. It is conceivable to produce the chopped strand at one place and transport it to another, in order to deliver it onto a web of resin paste. However, it is very difficult to handle chopped strand. The Applicant has therefore discovered that it is possible to produce firstly a strand mat in which the strands are bonded, in order subsequently to assemble said mat into an SMC sheet, possibly after a certain storage period. This is made possible thanks to the use of a binder, in order to give the mat strength so that it can be wound up, stored and handled, said binder being soluble in the thermosetting resin, thereby making it lose its binding character during SMC molding. This disappearance of the binder allows the SMC compound to flow satisfactorily during the molding operation.

The reinforcement may for example comprise glass strands. In particular, all the layers of the structure according to the invention may be made of glass strands. In general, the glass strand that car be used is sized in a manner known to those skilled in the art. Class strand sized to an amount of 0.04 to 3% by weight, and especially 1 to 2% by weight, may be used. The constituent material of the strands may comprise a fiberizable glass such as E-glass or the glass described in FR 2 768 144 or an alkaline-resistant glass called AR glass, which contains at least 5 mol % ZrO₂. In particular the use of AR glass leads to a mat which provides effective reinforcement of cement matrices or which can reinforce composites having a thermosetting matrix that have to come into contact with a corrosive environment. The glass may also be boron-free glass.

The reinforcement may comprise chopped strands or continuous strands. The reinforcement may comprise several layers of different strands for example a layer of continuous strands and a layer of chopped strands.

The fibrous structure may comprise a central layer of continuous strands that is placed between two layers of chopped strands. These two layers of chopped strands may be identical or different.

The manufacture of continuous strand mats has for example been disclosed in WO 98/10131 and WO 02/084005. The production of fibrous structures consisting of several layers has for example been disclosed in WO 03/060218. The techniques described in those references may be used to produce a mat or fibrous structure comprising a mat provided that what is used as binder is a binder soluble in the thermosetting resin used during the molding step.

Within the context of the present invention, it has also been discovered that it is possible to use not chopped strands but continuous strands within the context of SMC technology. This is because, unexpectedly, the web of continuous strands can flow sufficiently during the SMUG pressing operation. Although according to the prior art a chopped strand mat has never been used for SMC applications (since the chopped strands are sprayed and a mat is not isolated in an intermediate stage), it has now been discovered that a continuous strand mat can be used within the context of the SMC technique.

The use of continuous strands in SMC molding also leads to unexpected advantages in respect of the surface appearance, and more particularly the appearance of the edges of the final composites, and in respect of the uniformity of distribution of the fibers in the final composite. The Applicant has in fact discovered that the edges of the molded parts are much sharper, smoother and better formed than when chopped strands are used. Though this explanation should not be regarded as limiting the scope of the present applications it seems that the use of chopped strands means that a considerable number of ends of chopped strands end up at the surface or just beneath the surface of the edges of parts. This effect has its origin in the fact that the chopped strands naturally have an orientation parallel to the principal faces of the composite. This accumulation of chopped strand ends at the edges seems to promote the presence of porosity in the edges at the start of the process. The bubbles formed then expand under the effect of the temperature (around 200° C. for solidification of the thermosetting resin), which tends to deform the surface appearance of the edges. It seems that the use of continuous strands considerably reduces this effect. This is because, instead of a strand end at the surface (when chopped strands are used) there will be instead a loop of continuous strand, which results in a smoother surface. In addition, when chopped strand is used, the necessary flow of the SMC compound during molding gives the strands a preferred orientation, and this may result in surface undulations being independent, the chopped strands flow with the material too easily and orient along the flow lines. The strands may even agglomerate or form packets by keeping too much within these flows. In contrast, continuous strands are resistant to any orientation owing to their length, while still sufficiently following the expansion of the SMC during pressing. Consequently, the use of continuous strand results in more uniform reinforcement of the composite. For the same fiber content, the use of continuous strand generally results in a composite having a 5 to 12% higher stiffness compared with use of chopped strand. The use of chopped strand also makes it possible to produce a thinner part without degrading the surface appearance or the mechanical properties. Since the strands are not chopped, the surface appearance is better (as already explained above). Finally, the Applicant has discovered that continuous strand mat reinforces the part within its thickness and not just within a plane (the case with chopped strand), hence superior mechanical properties, such as tensile strength, are obtained.

The invention uses a fibrous structure comprising at least one mat consisting of chopped or continuous fibers, bonded together by a binder, said binder being soluble in the thermosetting resin no later than during the molding, it being possible for this binder to start dissolving as soon as the mat comes into contact with the thermosetting resin paste.

The invention relates in particular to a process for producing a sheet molding compound or prepreg sheet, comprising the combining of a thermosetting resin with a fibrous structure bonded together by a binder soluble in said thermosetting resin. In particular, the fibrous structure may be continuously unwound so as to be continuously incorporated between two layers of thermosetting resin paste.

It will be recalled that mats and felts differ appreciably insofar as a mat is a flat object, which can be used as a reinforcement, whereas a felt is an object having volume, which can be used for thermal insulation. In general, a mat has a thickness ranging from 0.8 to 5 mm, and mere generally from 1 to 3 mm, whereas as a felt is much thicker, generally having a thickness of greater than 1 cm A felt usually has a density ranging from 85 to 130 kg/m³. A mat is much denser, since its density may be around 300 kg/m³. However, for a flat reinforcement, the density of a mat is never expressed as its weight per unit volume but its weight per unit area. A fibrous structure for reinforcing composites using the SMC technology preferably has the following properties:
it must have sufficient cohesion to be able to be wound up (for storage and transport) and to be unwound;
it must not prick one's hands when it is being handled;
it must allow the SMC resin (generally of the polyester type and sometimes of the epoxy type) to impregnate it as easily as possible; and
it must reinforce the composite as much as possible.

The final composite must in general have the best possible impact strength, the lowest possible uncontrolled porosity (no unintentionally trapped gas bubbles) and the best possible surface appearance, including on the edges (narrow faces) of the final parts.

Within the context of the present invention, the fibrous structure comprising a mat (the structure may be only a mat) is chemically bonded. To do this, a chemical binder of the thermoplastic or thermosetting type, generally in powder form, is applied thereto and a heat treatment is then carried out which melts the thermoplastic or cures the thermoset (by polymerization and/or crosslinking) and finally, after cooling, bridges between the strands are created.

The binder may be used in liquid form (which includes solution, emulsion or suspension form), deposited by a device of the cascade or spraying type, or in powder form (deposited by a powder dispenser), or in film form.

In general, the binder may be used in the form of a powder, which can be sprayed onto the layer or the structure to be bonded. This binder may also be used in the form of a film placed between the layers to be linked together. A suitable heat treatment then melts, and then possibly cures, one compound of the binder so that it impregnates the various points that it has to link. If the binder comprises a thermoplastic polymer, the heat treatment melts this polymer so that it impregnates various points in the structure, and when the temperature returns to room temperature there is strong bridging between the various points to be linked. If the binder comprises a thermosetting compound (especially a polymer), the heat treatment causes this compound to crosslink and/or polymerize (possibly after melting), so that it links, via strong bridges, the various points to be linked together. In both cases (thermoplastic binder and thermosetting binder), the heat treatment also serves to evaporate off any solvent used for its application. The chemical compound may be a polyester resin of the thermosetting or thermoplastic type. For the crosslinkable (thermosetting) binder, an acrylic polymer may be used.

The various layers of the fibrous structure are linked together by the binder.

The final fibrous structure assembly (ready to be used in the SMC application) may comprise 0.5 to 15% and even 1 to 10% by weight of binder.

The nature of the binder may vary depending on the nature of the thermosetting resin, since one characteristic of the binder is to be soluble in the resin during the SMC molding operation, so as to free the strands from one another and to permit them to flow in the mold. The binder is at least soluble in the thermosetting resin at the cure temperature of said thermosetting resin. However, the binder may already have been dissolved in this resin as soon as it came into contact with the thermosetting resin paste at room temperature. In general, the binder dissolves sufficiently in the thermosetting resin between 50° C. and 200° C. The thermosetting resin generally cures between 150 and 300° C. When the thermosetting resin is a polyester, a polyester, especially of the thermoplastic type, may be in particular be used as binder. An unsaturated bisphenol polyester of high molecular weight may in particular be used.

The fibrous structure is incorporated into a sheet molding compound (SMC). The fibrous structure is therefore continuously inserted between two layers of thermosetting resin paste Said structure is unwound and then incorporated directly between two layers of resin paste. In addition to said structure, the addition of other reinforcement layers into the SMC is not excluded, such as for example chopped strands, especially chopped glass strands. Thus, a process may for example involve:
winding the fibrous structure so that it is laid horizontally on a first layer of resin paste; then
the chopped strands are sprayed onto said structure; and then
a second layer of resin paste is unwound onto the chopped strands.

It is also possible to place a layer of chopped strands before unwinding the fibrous structure.

The SMC sheet generally contains about 90 to 50%, and more particularly 80 to 60%, by weight of thermosetting resin, the balance consisting of the fibrous structure, which comprises the fibers, their size and the binder.

The sheet molding compound may be wound up, stored and handled in the same way as the sheet molding compounds of the prior art.

The SMC sheet may be used to manufacture a composite by molding the sheet by applying pressure to its principal faces, resulting in the sheet broadening out in the mold before the resin solidifies.

Before molding, the cut SMC sheet generally has an area ranging from 20 to 80% of the area of the final part. If the fibrous structure includes a continuous strand layer, the cut SMC sheet preferably has, before compression molding, an area representing 40 to 80% of the area of the mold (and therefore of the area of the final part). If the SMC sheet contains only chopped strands, the cut SMC sheet may have, before compression molding, an area representing 20 to 80% and more generally 25 to 40% of the area of the mold (and therefore of the area of the final part).

### EXAMPLES

Two series of sheet molding compounds containing 23% glass fiber and 77% polyester-resin-based paste were produced, one with glass in chopped strand form 50 mm in length) and the other with glass in continuous strand form. Before insertion into the SMC sheet, the fibrous structures were bonded in the form of a mat using an unsaturated blsphenol polyester. Rectangular parts representing 40% of the area of the final article were cut out and placed it an SMC mold. The hot compression molding operation was carried out. The flow lasted 3 seconds. After demolding, it was observed that the parts were well formed. The continuous-strand parts had a tenfold lower surface porosity than the chopped-strand parts (determined by visual observation—inspecting for blisters or pitting).

Moreover, in three-point bending (AFNOR standard 50705), the following tensile strength values were obtained
chopped strands: 175 MPa;
continuous strands: 185 MPa.

1: A process for producing a sheet molding compound or prepreg sheet, comprising the combining of a thermosetting resin with a fibrous structure bonded by a binder soluble in said thermosetting resin.

2: The process as claimed in claim 1, characterized in that the fibrous structure is continuously unwound so as to be continuously incorporated between two layers of thermo setting resin paste.

3: The process as claimed in claim 1, characterized in that the fibrous structure includes a layer of continuous strands.

4: The process as claimed in claim 1, characterized in that the fibrous structure includes glass strands.

5: The process as claimed in claim 1, characterized in that the binder is a thermoplastic binder.

6: A sheet molding compound comprising a thermosetting resin and a fibrous structure bonded by a binder soluble in said thermosetting resin.

7: The sheet molding compound as claimed in claim 6, characterized in that the fibrous structure includes a layer of continuous strands.

8: The sheet molding compound as claimed in claim 6, characterized in that the fibrous structure includes glass strands.

9: The sheet molding compound as claimed in claim 6, characterized in that the thermosetting resin is a polyester and in that the binder is a polyester.

10: The sheet molding compound as claimed in claim 6, characterized in that the binder is a thermoplastic binder.

11: The sheet molding compound as claimed in claim 6, in the 10 form of a roll.

12: A process for manufacturing a composite with a heat-cured matrix, which comprises the compression molding of a sheet molding compound of claim 6.

13: The process as claimed in claim 12, characterized in that, before molding, the sheet molding compound represents only 20 to 80% of the area of the final composite.

14: The process as claimed in claim 13, characterized in that the fibrous structure includes a layer of continuous strands and in that the area of the sheet molding compound represents 40 to 80% of the area of the final composite.
